(19) United States
(12) Patent Application Publication
(10) Pub. No.: US 2005/0071432 A1
(43) Pub. Date: Mar. 31, 2005

(54) Probabilistic email intrusion identification methods and systems

(76) Inventor: Clifton W. Royston III, Honolulu, HI (US)

Correspondence Address: BROWN, RAYSMAN, MILLSTEIN, FELDER & STEINER LLP, 900 THIRD AVENUE, NEW YORK, NY, 10022, US

(21) Appl. No.: 10/951,353

(22) Filed: Sep. 28, 2004

Related U.S. Application Data
(60) Provisional application No. 60/507,071, filed on Sep. 29, 2003.

(51) Int. Cl. G06F 15/16; G06F 11/30; H04L 9/00; H04L 9/32

(52) U.S. Cl. 709/206; 713/200

(57) ABSTRACT

The present invention provides computerized methods and systems for identifying email intrusion that includes the steps of performing a plurality of tests for determining if an email message is an email intrusion on at least one email message, each of the plurality of tests having a detection accuracy probability associated therewith, computing an overall detection accuracy probability based at least in part on the product of the detection accuracy probabilities associated with each of the tests; and disposing an email message determined to be an email intrusion based on the computed overall probability in accordance with one of a plurality of possible disposition for the email message.

This application claims the benefit of U.S. Provisional Application No. 60/507,071, filed 29 Sep. 2003.

### BACKGROUND OF THE INVENTION

The present invention relates to methods and systems for identifying and/or filtering email intrusions. Particularly, the present invention relates to methods and systems for determining whether email messages are unsolicited email, undesirable and/or offensive email, contain email malicious software, such as a virus, a Trojan horse, etc., or other undesirable content, separately or in combination.

Normal incoming email messages flow steadily into a computer network, typically over the Internet, and must be accepted and delivered to the proper recipient accordingly. In many cases the incoming messages contain critical business transactions or essential personal communications. At the same time other messages or email intrusions, such as spam or malware, such as viruses, Trojan horses, etc., are interspersed within the message stream that may not necessarily be desired by their recipients and pose either a nuisance or a threat to the recipient's computer system. The term “email intrusions” is generally used herein to denote any type of undesirable and/or offensive email message, including but not limited to spam, email messages with explicit or pornographic content, and malicious software (“malware”). Malware is used herein to denote any type of software code or instruction set designed to damage or disrupt computer devices or systems. An email message generally denotes an object or item in an electronic or computer readable form, including electronic documents, files, attachments, code, etc., that is capable of being communicated between parties, e.g., over a communication network.

Email intrusions, e.g., unsolicited email, more commonly known as “spam”, and email malware, such as viruses, have become so prevalent that virtually any person with email access is burdened to some degree with problems associated therewith. It is estimated, for instance, that as of 2003 as much as one half of email is spam. Accordingly, companies and individuals using email communication, for example, to conduct business can expect a proportional cost in terms of lost productivity, and wasted Internet bandwidth and network infrastructure for handling and/or filtering email messages for spam and malware.

In response to email intrusions, the software industry has adopted software products for filtering email intrusion that incorporate various approaches with regard to identifying whether or not an email message is an email intrusion. Common methods for identifying spam, for instance, include domain name system (“DNS”) based blocking lists, which attempt to identify spam sources by originating IP address, regular expression matching (“regexes”) of text or symbols that commonly appear in either the body or headers of spam, header analysis for inconsistencies, statistical analysis, e.g., as described in U.S. Pat. No. 6,161,130, content type rejection commonly used in spam or malware, such as HTML email or attached executable files, distributed email identification mechanism using a centrally stored checksum/hash, token based email acceptance or rejection, and white lists. Common methods for detecting malware in email messages include comparing incoming email with known malware or virus signatures or with known malware or virus vectors based on the type of attachment.

The methods used in the art for identifying email intrusions, however, are deficient in many respects. Rules based filtering, for instance, is subject to “diminishing returns.” That is, rules may be implemented to filter out a great deal of email intrusions, however, stricter rules are required to filter the last few percent of spam and consequently result in increased misidentification, i.e., false positives. Therefore, in order to increase the percentage of correctly identified spam, a large number of increasingly elaborate rules are required to effectively increase the percentage of correctly identified spam by a marginal or fraction of a percent. In many instances, the effort required to develop the large number of elaborate rules may not warrant the marginal benefit in correct identification particularly since approaches to email intrusions change frequently which results in rules gradually losing their effectiveness over time.

Additionally, rules based filtering, particularly with regard to filtering that involves textual analysis to identify email intrusions, have a high computational cost associated therewith, which is compounded with the need for a large number of elaborate rules to yield a high accuracy with regard to positive identification. At times, the computation demand may even slow down mail servers below the rate at which the servers must operate to process mail normally, and also consume an excess amount of CPU and memory resources. In many instances large companies process a sufficiently high volume of mail to require deploying several high-end mail servers that operate in parallel to screen incoming mail for a single final-delivery mail server.

Accordingly, there is a need for computerized methods and systems for increasing the accuracy with regard to identifying email intrusions without necessarily resorting to increasingly elaborate rules that provide marginal added measure of accuracy. Moreover, there is a need for methods and systems for identifying email intrusions while minimizing the computation cost associated with the identification, particularly in instances of relatively high mail volumes.

### SUMMARY OF THE INVENTION

The present invention generally provides methods and systems for identifying and/or filtering or screening out email intrusions from valid email while minimizing the chance of discarding valid email or impairing the function of the email system. In certain aspects of the present invention, this is accomplished by providing novel approaches for identifying email intrusions that involve probabilistic analysis of email messages.

In one aspect of the invention, computerized methods and systems are provided for identifying email intrusions by performing a plurality of tests for determining if an email message is an email intrusion on at least one email message, computing an overall detection accuracy probability based at least in part on the product of the detection accuracy probabilities associated with each of the plurality of tests performed, and determining whether the email message is an intrusion based on the overall detection accuracy probability. It is understood that various types of tests for determining if an email message is an email intrusion, now known or hereinafter developed, may be performed in furtherance of the present invention, including header pattern matching, body pattern matching, domain name system (“DNS”) based checking, regular expression matching (“regexes”), statistical analysis or analyses, content type based identification, distributed email based identification, token based email identification, comparison with known malware or virus signatures or with known malware or virus vectors, etc. In one embodiment, the plurality of tests for determining whether an email message is an email intrusion are performed to determine if an email message is either spam or a malware.

The detection accuracy probability for each of the plurality of tests for determining whether an email message is an email intrusion may be derived in a number of ways as will be evident to those skilled in this art. In one embodiment, the detection accuracy of each of the tests is determined based on assessing the detection accuracy of each of the plurality of tests against a plurality of email messages that are either known or presumed to be email intrusions and a plurality of valid messages known not to be intrusions. The assessment will generally be made at least once to provide the email system with a detection accuracy probability data set for use in identifying and/or disposing email intrusions. The assessment may also be made periodically, such as monthly, quarterly, annually, etc., to provide a current or timely detection accuracy data set. This aspect accounts for the frequent changes with regard to the approaches taken by email intruders to circumvent email intrusion filtering.

In another embodiment, the detection accuracy for each of the plurality of tests for determining if an email message is an intrusion is determined based at least in part on a measured accuracy. The measured accuracy generally accounts for the actual performance of the particular test in detecting email intrusions. In one embodiment, the actual measured accuracy is determined based on user feedback. Notice with regard to misidentifications, e.g., false positives or false negatives, may be fed back to the system to update the measured accuracy of the tests and thereby accounted for in subsequent identifications. The measured accuracy may also be user specific. That is, the performance of each or all of the tests with regard to identifying email intrusions may be computed or determined separately for each email recipient. Thus, a user specific detection accuracy probability data set may be applied to determine whether or not an email message is an email intrusion for each email recipient. This aspect of the invention recognizes that the determination of whether an email message is an intrusion is somewhat subjective. For instance, spam involving low refinance mortgage rates may not necessarily be objectionable to individuals in the market to refinance a mortgage.

In another aspect of the present invention, computerized methods and systems are provided for testing email messages which includes determining an email system load and bypassing at least one of a plurality of tests for determining if an email message is an email intrusion based on the detection accuracy probability associated with the test being bypassed and the email system load.

In another embodiment, the detection process for email intrusions may include further determining a computation cost for performing at least one test for determining if an email message is an email intrusion or a load on the email system, e.g., at the time of testing, and bypassing at least one of the plurality of tests based on the detection accuracy probability associated with the test being bypassed and the email system load and/or the computational cost for performing the test. The detection accuracy probability may be considered individually or in the context of the test's contribution to the overall detection accuracy probability as described below. This aspect of the present invention realizes the computational cost and/or the added system load associated with performing each of the plurality of tests, and bypasses certain tests that would provide a marginal benefit with regard to the overall accuracy of email intrusion identification, particularly, when relatively high demands are placed on the email system. The particular thresholds for bypassing tests with respect to the computational cost or the load on the email system may be either predefined or user defined. The computational cost or load on the email system may be measured, e.g., at the time of testing, or estimated based on prior measurements. Alternatively or in addition, testing may be deferred, e.g., at times of low or lower demand on the system. The deferral may be triggered, for example, if an unacceptable overall detection accuracy will be achieved by bypassing a particular test or tests.

In another aspect of the present invention, computerized methods and systems are provided for testing email messages that includes determining an email system load, computing a computational cost of performing at least one test of a plurality of tests for determining if an email message is an email intrusion, and bypassing at least one test of the plurality of tests based on the computational cost and the detection accuracy probability of the bypassed test.

In some embodiments, mathematical game theory is incorporated into decision-making with regard to identifying and/or disposing email intrusions. Game theory generally involves decision-making based on the expected payoff or expected cost of the decision. In one embodiment, email intrusions are identified by further deciding whether an email message is an intrusion based on an expected cost for disposing of the email message in comparison to the expected cost of each of a plurality of possible dispositions. The expected cost for disposing the email message may be computed various ways as will be evident to those skilled in this art. In one embodiment, the expected cost is determined based on the detection accuracy probability of at least one of the plurality of tests for determining whether an email message is an email intrusion, the overall detection accuracy probability, or a combination thereof.

In one embodiment, the detection process for email intrusions may include further determining that a plurality of email messages from a particular originator or host are email intrusions and blocking subsequent email intrusions from the same host or originator. This feature may be provided by integrating various email system components throughout the email system so that email intrusion information may be fed to each of the software components to allow the system to respond robustly to a surge or email intrusions, e.g., by dynamically limiting throughput from those IP addresses originating them. In one embodiment, the present invention integrates email software components including the message transfer agent (“MTA”) component and the message mail user agent (“MUA”) component, which advantageously allows for efficient identification of a stream of email messages rather than merely a single message. For example, if a host sends three email intrusions consecutively to a mail server, the following consecutively received message from that particular host is thus more probable to be an intrusion as well. By integrating various components of the email system intrusion information can be fed back to the MTA to block email messages from the host or originator.

In one embodiment, email messages that have been identified as email intrusions are tagged as such accordingly. A reliability score may also be assigned to the tagged message based on the overall detection accuracy probability. Email messages may then be disposed of, e.g., deleted, quarantined, labeled, etc., according to the reliability score and a reliability threshold assigned to each type of disposition, which may be user defined. For example, where possible disposition includes deleting or quarantining two reliability thresholds may be used to define the range for which each of the dispositions will be triggered. Thresholds may also be domain or host specific. That is, email messages from certain originators or class of originators may disposed of on a stricter basis than others, e.g., un-trusted vs. trusted originators. For example, messages from hotmail accounts may be deleted if assigned a reliability score above 0.80 or 80%, whereas messages from originators in an industry relevant to the email recipient may be deleted if assigned a reliability score above 0.99 or 99%. Email messages identified to be email intrusion may also be placed in one of a plurality of folders based on the reliability score assigned to the tagged message and offensive content may be redacted from the email intrusion.

In another aspect of the present invention computerized methods and systems are provided for identifying and/or disposing of email messages that includes computing a plurality of expected costs of disposing the email message each associated with one of a plurality of possible dispositions for an email message and disposing the email message based on the expected cost, e.g., the lowest expected cost. The expected cost for disposing of the email message may be computed in various ways and may account for costs associated with reduced productivity, loss due to misidentification or erroneous disposition, etc. In one embodiment, the expected cost is determined based at least in part on either a detection accuracy probability of at least one of the plurality of tests for determining whether an email message is an email intrusion, an overall detection accuracy probability associated with a plurality of tests for determining whether an email message is an email intrusion, or a combination thereof. The expected cost may also be user specific and test specific. This feature recognizes that the cost associated with, for example, deleting a particular message based on a particular test may vary between individuals. For example, a false positive with regard to textual test for “Viagra” may be insignificant to most, whereas, a false positive in this respect may be significant to those in the pharmaceutical industry that may receive email messages with the word “Viagra.”

As will occur to those familiar with the applicable arts, upon reviewing this specification, a great many configurations of support devices according to the invention are possible and will serve to accomplish the purposes described herein.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a flow diagram of a process for identifying email intrusion according to one embodiment of the invention.

FIG. 2 is flow diagram of a process for disposing of email messages according to one embodiment of the invention.

FIG. 3 is a block diagram of a system for identifying email intrusions according to one embodiment of the invention.

### DETAILED DESCRIPTION OF THE PREFERRED EMBODIMENTS

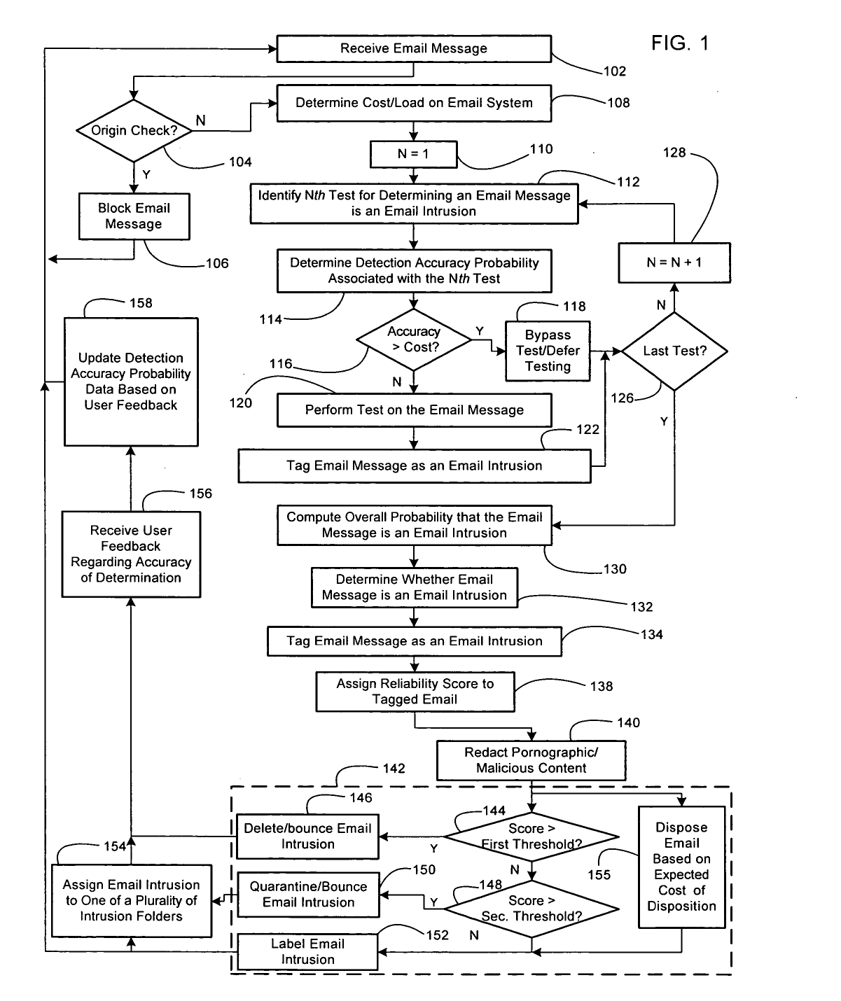

Referring to FIG. 1, in one embodiment, a method of identifying email intrusions begins at 102 by receiving at least one email message. The email message as noted above is generally an object or item in an electronic or computer form that is capable of being communicated between parties, e.g., from an originator to an email recipient, over a communication network, such as the Internet, a local area network (“LAN”), a wide area network (“WAN”), etc., or a combination thereof.

At 104, the origins of the email message may be tested to determine whether or not the email message is an email intrusion. Origin testing may either provide an automatic positive or negative determination of whether the email message is an email intrusion. Various methods can be used to make this initial determination, including white lists, black lists, etc. In one embodiment, information regarding prior positive identifications, such as the originator's domain name, the number of identification for a particular originator, the timing of the positive identifications, etc., are fed back to a message transfer agent (“MTA”) that controls incoming communications into the email system. The MTA may then respond dynamically at 106 and block subsequent and/or future email messages from the particular originator based on the number and/or timing of the email intrusions from the particular originator.

In one embodiment, at 108-120, a cost conscious approach is generally applied to determine whether or not to perform one or more tests for determining whether an email messages is an email intrusion of a plurality of such tests. Various types of costs may be the basis of such a determination, including computational costs, bandwidth consumption, resource consumption, system loads, etc., and may be either time dependent or independent, e.g., cost or load at a particular time, such as at the time the email message will be assessed to determine whether or not the message is an email intrusion.

At 108, in one embodiment, a computational cost for performing the test or load on the email system is determined. The determination may be an actual load measured at the time that the email message will be assessed, or an estimated cost or load based on prior determinations. At 110-112, a first test (N=1) for determining whether or not an email message is an email intrusion of a plurality of such tests is identified, and at 114 a detection accuracy probability associated with the first test is determined. As noted above, various types of tests may be performed in furtherance of the present invention, including header pattern matching, body pattern matching, domain name system (“DNS”) based checking, regular expression matching (“regexes”), statistical analysis or analyses, content type based identification, distributed email based identification, token based email identification, comparison with know known malware or virus signatures or with known malware or virus vectors, etc. In one embodiment, the first test is of a type of test selected from a group that includes header pattern matching, body pattern matching, and DNS based checking. In one embodiment, the first test of the plurality of tests identified has a relatively high detection accuracy probability associated therewith or has the highest detection accuracy probability in relation to the detection accuracy probabilities of the plurality of the tests.

The detection accuracy probability for correctly identifying an email message as an email intrusion for the first as well as each of the plurality of tests for determining whether an email message is an email intrusion (the probability data set) may be estimated, e.g., based on an assessment against a plurality of email messages that are either known or presumed to be email intrusions and a plurality of valid messages known or presumed to be intrusions, measured based on user feedback with regard to the accuracy of prior identifications, or a combination thereof. The probability data set is generally computed at least once, and preferably periodically, such as weekly, monthly, quarterly, annually, etc.

In one embodiment, at 116 if the accuracy of the first test is greater than the cost associated with performing the first test at the particular time that testing would occur, the first test is bypassed at 118. The cost and detection accuracy threshold may vary based on system configuration, e.g., slow vs. fast email servers, desired detection accuracies, etc. For example, a relatively overburdened system during peak hours may require bypassing tests with less than a 0.99 (99%) accuracy and/or if the computational cost is greater than a particular amount, whereas during off peak hours the system may require performing all tests regardless of the computational cost or load that would be placed on the system for performing the test. In one embodiment, the tests are identified in order of their detection accuracy probability. In this instance, the first test will not likely be bypassed unless delivery of untested email is acceptable. If, however, the email system is burdened to the extent that the first as well as subsequent tests would be bypassed, testing may be deferred to a later time.

If at 116 the accuracy of the first test is greater than the cost associated with performing the first test, the test is performed on the received email message at 120, and at 122 the email message is tagged, e.g. by inserting a unique token associated with the first test therein, which identifies the email message as an email intrusion or not an intrusion. In one embodiment, the tag is associated with or includes a numerical indicator between 0 and 1 that is based on or indicates the detection accuracy probability associated with the particular test.

In either event, the system will proceed to identify at 112 the next test, i.e., the N+1 test, for determining whether the email message is an email intrusion, determine at 114 the detection accuracy probability associated therewith, compare at 116 the accuracy with the cost or load for performing the test, and either bypass the test at 118 or perform the test at 120, tag the message at 122, and associate or include a detection accuracy probability numerical indicator with the tag accordingly until the last test is identified at 126. In one embodiment, the plurality of tests for determining whether or not an email messages is an email intrusion are identified in a descending order with respect to the detection accuracy probability. The tests will therefore be identified beginning with tests having the highest detection probability, and proceeding through to the lowest detection accuracy probability or until a threshold detection accuracy probability is reached.

Once the final test is performed, an overall probability that the email message is an email intrusion is computed at 130. Various methods may be used to compute the overall probability, known now or hereinafter developed, as will be evident to those skilled in this art. In one embodiment, the overall probability is computed at least in part via a mathematical formula for combining the detection accuracy probability that involves at least in part computing the Bayesian conditional probability product of the detection accuracy probabilities associated with each of the tests for determining whether or not the email message is an email intrusion that were performed on the email message with the following algorithm:

$$P = \frac{P ( {T}_{1} ) * P ( {T}_{2} ) * … * P ( {T}_{i} )}{\begin{matrix}( P ( {T}_{1} ) * P ( {T}_{2} ) * … * P ( {T}_{i} ) ) + \\ ( 1 - P ( {T}_{1} ) ) * ( 1 - P ( {T}_{2} ) ) * … * ( 1 - P ( {T}_{i} ) )\end{matrix}}$$

where
   P=the overall probability,
   P(Tᵢ)=the detection accuracy probability of the i^{th} test, and
   i=a whole number indicative of the total number of test performed.
      In another embodiment, the overall probability is computed with an alternative statistical formula for combining the detection accuracy probabilities associated with each of the tests, such as the Chi-square formula, or with a combination of two or more formulas.

The overall probability may then be used to determine at 132 whether or not the email message is an email intrusion. Various methods may be used to make the determination based on the computed overall probability. The determination may, for instance, be made based on a reliability threshold, user defined or otherwise, or on an expected cost associated with a particular type of disposition of a plurality of possible dispositions (described in greater detail below). At 134 an email message identified as an email intrusion based on the overall probability may be tagged accordingly to identify the message as such, and a reliability score based on the overall probability may be assigned at 138 to the tagged email message. In one embodiment, suspected pornographic or offensive, such as textual items, graphic items, etc., or malicious content, such as executable code, macros, etc., is redacted at 140 from the email message identified as an email intrusion prior to delivery.

The email message may then be disposed of at 142 at least in part based on the detection accuracy probability of one or more of the tests performed on the email message, or the overall probability. In one embodiment, disposition is achieved by comparing the overall reliability score at 144 with a first reliability threshold that triggers deleting or bouncing an email message having a reliability score greater than the first reliability threshold, which may be user defined or otherwise. If at 144 the reliability score is greater than the first reliability threshold, the email is either deleted and/or bounced at 146. Bouncing an email message generally refers to blocking, refusing, or otherwise preventing delivery of an email message, and sending notice to the originator of the message that the message has not been delivered.

If at 144 the reliability score is not greater than the first reliability threshold, the email message is compared with a second reliability threshold that triggers whether or not the email message will be quarantined at 148. Quarantining is used herein to generally denote redirecting an email message to a quarantine area for access for false positive recovery, e.g., in the event the email message has been incorrectly identified as an email intrusion. If at 148 the reliability score is greater than the second threshold, the email message is quarantined and/or bounced at 150. If, however, at 148 the reliability score is not greater than the second threshold, the email message may be delivered accordingly. The email message may further be compared to a third threshold that triggers the labeling of the email message as an email intrusion at 152. Email messages, either quarantined or labeled may be assigned at 154 to one of a plurality of intrusion folders based on the type of intrusion. For example, the email messages may be placed in a suspected pornographic content/spam email message folder, a suspected malware folder (with the malicious code redacted), etc.

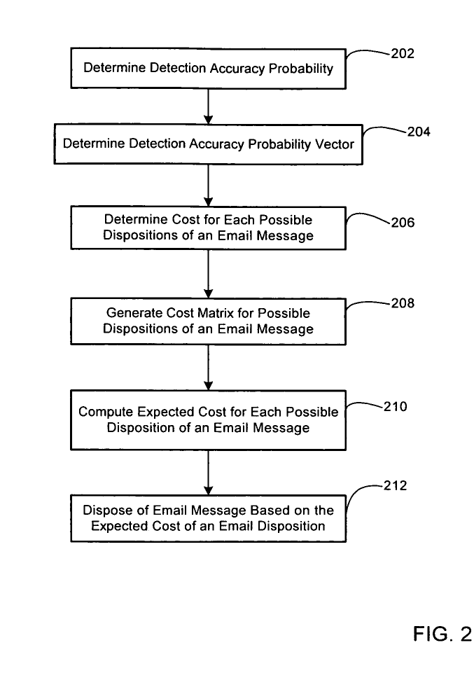

Alternatively or in combination, the email message may be disposed of at 155 based on mathematic game theory or an expected cost associated with a particular type of disposition of a plurality of possible dispositions, such as delivering the email message normally, labeling the email message, quarantining the email message, and deleting the email message. In one embodiment, email intrusions are identified by further deciding whether to treat an email message is an intrusion based on an expected cost or payoff for disposing the email message from a plurality of possible dispositions. The expected cost for disposing the email message may be computed various ways, including based on either the detection accuracy probability of at least one of the plurality of tests for determining whether an email message is an email intrusion, the overall detection accuracy probability, or a combination thereof. Various ways for disposing email based on the probability and cost are discussed in more detail below in connection with FIG. 2.

In one embodiment, user feedback regarding the accuracy of identifications and/or dispositions are received at 156 and used to update at 158 the detection accuracy probability data for one or more tests for determining whether an email message is an email intrusion, thereby providing a detection accuracy probability data set that is at least partially based on the actual performance of the test or tests. The measured detection accuracy probability data set may be maintained individually for one or more users, or user groups, to provide email intrusion identifications based on user specific data sets.

Referring to FIG. 2, email disposition is accomplished according to one embodiment by determining at 202 a detection accuracy probability associated with at least one test for determining whether an email message is an email intrusion that has or would be performed on the email message, an overall detection accuracy probability for a plurality of tests performed or to be performed by the system, or a combination thereof. The overall detection accuracy probability vector is computed or otherwise determined at 204, which may later be multiplied by the payoff matrix, as discussed below. The overall detection accuracy probability may be expressed as follows:
(P(1-Tₒ),P(Tₒ)),
where
   P(Tₒ)=the probability that the email message is an email intrusion, and
   P(1-Tₒ)=the probability that the email message is valid email or not an intrusion.

The test for determining whether an email message is an email intrusion and the detection accuracy probability associated therewith may be defined with greater granularity or specificity than simply “email intrusion” or “valid.” For example, the test may be characterized based on fine-grained categories, such as spam, malware, particular types of malware, particular viruses, explicit content, particular explicit content, etc. Accordingly, dispositions can be made based on the probability or confidence level that a particular email falls into a particular fine-grained category.

The system may then assign relative costs to different possible dispositions of an email message based on the category the possible disposition falls into. For instance, delivering an email with spam, explicit, or malware content may have various increasing costs, while failing to deliver some valid emails may have extremely high costs. The relative cost may be predefined or user defined, and may be user, group, industry specific, etc. For example, the cost for a false positive on a test for “Viagra” may be negligible for most, whereas the cost may be relatively high for those in the pharmaceutical industry. A relative cost matrix for the possible dispositions may then be generated at 208, the expected cost for each possible disposition of an email message computed at 210, e.g., by multiplying the probability vector with the relative cost matrix, and the email message may be disposed of at 212 based on the net expected cost or costs of an email disposition.

For example, assume the average cost of the effort and time for an employee to read and delete an unlabelled spam message is $1.00, while the effort and time for them to delete spam which has been labeled in its subject line is only $0.10, there is a cost of $0.01 to review a quarantine entry in a daily report, and there is no effort or cost for a deleted spam. Assume also that the cost of processing a normal business or personal mail is disregarded ($0.00), the extra cost of identifying and reading an email message which is delivered mislabeled as spam is $0.20, the cost of the effort and time for them to identify and retrieve a misfiled email from quarantine is $2.00, while the relative cost of the system completely deleting an email is $200.00 (due to the high cost of losing an important email about a business contract). This generates a relative cost matrix of:

| | Normal | | | |
|---|---|---|---|---|
| | delivery | Label subject | Quarantine mail | Delete mail |
| False Pos. | $0.00 | −$0.20 | −$2.00 | −$200.00 |
| Spam | −$1.00 | −$0.10 | −$0.01 | $0.00 |

In this example, all payoffs are expressed as negative values relative to the assumed desired state in which all desired mail is delivered and no spam is received or delivered. The same method may be applied without loss of generality to a matrix which includes positive payoffs.

By adapting the mathematical concepts of game theory to analyzing the matrix, in conjunction with a detection accuracy probability for a specific incoming email, an expected resultant cost or net “payoff” may be determined for each of the categories and/or dispositions. Further, assume for example that an overall probability that an email message has been correctly identified as an email intrusion is 0.999 (99.9%), and hence has 0.001 (0.1%) probability of being valid email, e.g., tested false positive. The relative cost matrix may then be multiplied by the vector (0.001, 0.999) to yield the following expected cost matrix:

| | Normal | | | |
|---|---|---|---|---|
| | delivery | Label subject | Quarantine mail | Delete mail |
| *0.001 | 0.00 | −0.0002 | −0.002 | −0.20 |
| *0.999 | −0.999 | −0.0999 | −0.00999 | 0.00 |
| Payoff-sums: | −0.999 | −0.1001 | −0.01199 | −0.20 |

From the resulting payoff sums, it can be seen that the expected resultant cost for the quarantine disposition has the least negative expected cost associated therewith, and the quarantine disposition may then be automatically chosen.

Similarly, if the incoming email were instead assessed as having 0.999999 probability of being spam, and 0.000001 probability of being valid, e.g., tested false positive, the following expected cost matrix is produced:

| | Normal | | | |
|---|---|---|---|---|
| | delivery | Label subject | Quarantine mail | Delete mail |
| *0.000001 | 0.00 | −0.0000002 | −0.00000200 | −0.00020 |
| *0.999999 | −0.999999 | −0.0999999 | 0.00999999 | 0.00 |
| Payoff-sums: | −0.999999 | −0.1000001 | −0.01000199 | −0.00020 |

It can be seen in this instance that the expected resultant cost for the deletion disposition has the least negative expected resultant cost or payoff and the deletion disposition may then be automatically chosen.

In another embodiment, the system applies randomization concepts of game theory to improve the overall probability that mail is handled in the desired way by randomly selecting a method of disposing an email message from a plurality of possible dispositions with specific probabilities associated with each disposition as a function of the email's rating probability. For example, if the filtering system at the delivery phase estimates an email to be an intrusion with a 99.8% probability, then dependent on the value placed by the system on rejecting spam versus losing valid email, the system might randomly choose from a 2% probability of delivering the message with no intrusion indicator, a 90% probability of delivering the message with an indicator that it is spam, and an 8% probability of sending the message to a quarantine area, where the weightings are pre-programmed according to a rule.

In another embodiment, the system assigns relative costs to different possible dispositions of an email message depending on the category the email message falls into, and applies the “optimal mixed strategy” concepts of game theory to improve the overall probability that the email message is handled in the desired way by randomly selecting a method of disposing an email message from a plurality of dispositions or by assigning a probability to each disposition as a function of the expected payoffs which have been associated with the disposition as a function of the theoretical decision/payoff matrix as discussed above.

In one embodiment, some probability-valued function over all possible resulting vectors of the payoff values is defined and applied to the payoff vector such that the sum of all results for any value of the payoff vector sum is 1.00, and such that the result with the most positive or least negative payoff magnitude is the most probable and that results are proportionally likely in inverse proportion to their undesirability. In one embodiment, the following probability-valued function is applied:
P(Disposition)=Ratio(Disposition)/Total(Ratio(Disposition))
where
   P(Disposition)=the probability of a particular disposition, and
   Ratio(Disposition)=Total(all Payoff-sums)/Payoff-sum(Disposition)

For example, assuming 99.9% confidence that a particular email is spam the expected resultant cost or negative payoff sums are as follows:

| | Normal | | | |
|---|---|---|---|---|
| | delivery | Label subject | Quarantine mail | Delete mail |
| Payoff-sums: | −0.999 | −0.1001 | −0.01199 | −0.20 |

| | | |
|---|---|---|
| Total of Payoff-sums = | −1.31109 | |
| Ratio(Normal) = | −1.31109/−0.999 = | 1.312 |
| Ratio(Label) = | −1.31109/−0.1001 = | 13.097 |
| Ratio(Quarantine) = | −1.31109/−0.01199 = | 109.349 |
| Ratio(Delete) = | −1.31109/−0.20 = | 6.555 |
| Total(Ratio) = | | 130.313 |

Using this specified probability function, the predicted optimal strategy for the email message and the valuation of costs would be a selection, random or otherwise, from:
Prob(Normal)=1.312/130.313=0.0101 (1.01%)
Prob(Label)=13.097/130.313=0.1005 (10.05%)
Prob(Quarantine)=109.349/130.313=0.8391 (83.91%)
Prob(Delete)=6.555/130.313=0.0503 (5.03%)

In another embodiment, the system is adopted to analyze email messages for delivery in multiple stages based on a degree of information regarding the email message available at each stage and to assign relative costs to each of the stages. The level of testing to determine whether the email message is an email intrusion may therefore be optimized based on the expected cost at the individual stages. For example, the system may estimate or associate the expected cost at a very earliest stage of email message delivery, e.g., before any of the message content is received, with the following set of possible dispositions at the early stage: Accept/Deliver (accept mail for delivery without further tests); Accept/Test (accept mail for further analysis and testing); Defer (request a temporary deferral of the email delivery); Reject (refuse mail without accepting it onto the system). Based on the information regarding the email message available to the system, e.g., information regarding the originator's IP address, self-identification of the originating server, the originator's email address, the recipients email address, etc., the system may account for the relative expected cost matrix to dispose of the email message, i.e., to determine whether or not to deliver the message prior to further testing thereby conserving computation costs.

In another embodiment, the system is adapted to perform a multiple stage delivery analysis, as noted above, and in addition to optimize the level of testing based on the expected cost at each stage and on the load and state of the email system. The load may be monitored constantly to dynamically optimize the level of testing of email messages. For example, assuming a system was under heavy load, e.g., due to a heavy spam “attack”, the system could dynamically self-adjust its costs in the initial phase to significantly increase the negative cost it assigns to the “Accept/Test” option and moderately increase the negative cost it assigns to the “Accept/Deliver” option based on the load, and/or the added load and computation cost for performing the tests, such that email that has a high probability of being spam has an increased likelihood of being immediately rejected without extensive analysis and email that has a relatively low probability of being spam has a moderately increased likelihood of either being deferred or being accepted without full analysis. Additionally, under heavy load the performance of the system and the overall outcome could be improved by disabling the most computationally expensive tests either on all messages or on specific messages based on a per-message assessment.

In another embodiment, the system that is capable of performing a multistage delivery analysis, as noted above, is further adopted to provide feedback regarding the results of later stages, which typically involve more extensive analysis, to earlier analysis stages so that information regarding later high probability identifications can be accounted for at the earlier stages. Thus, email messages from the same source, e.g., IP address, email sender address, etc., as email messages previously identified as email intrusions with a high probability may be disposed of accordingly at the early stages. For example, information regarding the source server and sender of an email message identified with a high-probability as spam may be entered into a dynamically updated database that may be accessed at earlier stages to dispose of the email message at the earlier stage. Alternatively, the email message is preliminarily identified as an email intrusion at the initial or earlier analysis stage and may either be rejected, deferred, or selected for full testing. Conversely, if a particular email is identified with a high probability as valid mail, the information about its source sender can be stored and used similarly to reduce the load on the email system, such as by delivering the email message without further testing. This aspect of the present invention would greatly reduce the proportion of spam that needs to be accepted for analysis while only minimally affecting normal email delivery because email delivery is normally retried by mail servers.

It is understood that the features of the present invention may be adopted to identify and/or filter email messages on a variety of different computer systems and a variety of computer system configurations. For instance, the present invention may be embodied in software resident on a client computer that filters incoming email independent of the email server. The present invention may also be embodied in software resident of a mail server computer that filters incoming email before the client computer. Additionally, the functionality of the present invention may be packaged together with email server products or may be designed to integrate with existing email server products.

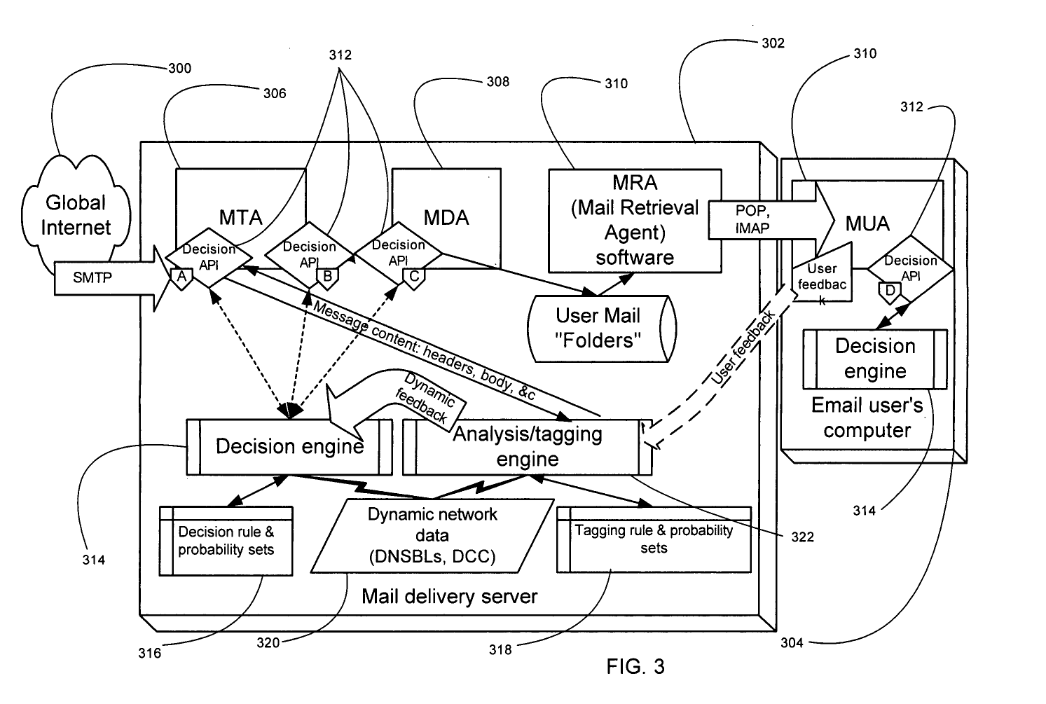

Referring to FIG. 3, in one embodiment of the present invention, a computer system is provided that includes at least one computing device, such as an email server 302, client computer 304, etc., having software associated therewith that when executed perform the various functions described above. The software is generally stored on a computer readable medium, such as optical media, magnetic media, hard disks, etc., that may be accessed and executed by the computing device to identify and/or filter email messages.

In one embodiment, software is provided that interfaces with email system software, such as Sendmail, Microsoft Exchange Server, Postfix, etc., to provide the relevant functionality described herein. The software generally includes at least one decision engine 314 and at least one analysis engine 322. The decision engine 314 accesses decisions rules and probability rules, e.g., stored on a decision rule database 316 to identify email intrusions therewith. The analysis engine 322 accesses tagging rules and probability data sets, e.g., stored on a tagging rule database 318. The decision engine 314 and analysis engine 322 may further access dynamic network data, e.g., stored on a dynamic network data database 320, to analyze incoming email messages and provide feedback to the decision engine 314 for determining whether an email message is an email intrusion.

In one embodiment, the decision engine or engines 314 interface with at least one email system component, such as a message transfer agent (“MTA”) 306, message delivery agent (“MDA”) 308, mail retrieval agent (“MRA”) 310, message user agent (“MUA”) 310, etc., with at least one decision API 312 to dispose of the email message accordingly, e.g., to block, bounce, quarantine, label, etc. In this instance, the analysis engine 322 receives email message content from the MTA 306. In one embodiment, the system includes a decision engine 314 that interfaces with the MUA 310 to enable user feedback data to be provided to the analysis engine 322, e.g., for updating the probability data set based on actual identification performance.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

1. A computerized method for identifying email intrusions comprising:
performing a plurality of tests for determining if an email message is an email intrusion on at least one email message, each of the plurality of tests having a detection accuracy probability associated therewith;
computing an overall detection accuracy probability based at least in part on the product of the detection accuracy probabilities associated with each of the tests performed; and
disposing of an email message determined to be an email intrusion based at least in part on the computed overall detection accuracy probability in accordance with one of a plurality of possible dispositions for the email message.

2. The method of claim 1, comprising determining an email system load and bypassing at least one of the plurality of tests for determining if an email message is an email intrusion based on the detection accuracy probability associated with the test being bypassed and the email system load.

3. The method of claim 1, comprising computing a computational cost of performing at least one test for determining if an email message is an email intrusion and bypassing at least one test of the plurality of tests based on the computational cost and the detection accuracy probability of the bypassed test.

4. The method of claim 1, comprising bypassing at least one test of the plurality of tests having a marginal benefit to the overall detection accuracy probability in relation to one of a computational cost for performing the test and a load on an email system for performing the test.

5. The method of claim 1, comprising computing an expected cost for disposing of an email intrusion for each of the plurality of possible dispositions, wherein a disposition for a specific email suspected to be an email intrusion is selected based on the expected costs of disposing an email intrusion.

6. The method of claim 5, wherein the expected cost of disposing an email intrusion is based at least in part on the overall detection accuracy probability.

7. The method of claim 5, comprising disposing the email message determined to be an email intrusion based on the expected cost of each of the plurality of possible dispositions for the email message.

8. The method of claim 7, wherein the plurality of possible dispositions comprises delivering, deleting, quarantining, and labeling the email message.

9. The method of claim 5, wherein the expected cost of each of the plurality of possible dispositions is determined on at least one of a user specific and a test specific basis.

10. The method of claim 5, comprising applying an optimal mixed strategy from mathematical game theory to a matrix of the costs associated with the plurality of possible dispositions to select a predicted most favorable disposition for each specific email message either deterministically or randomly based on a computation of the strategy, and disposing of the message accordingly.

11. The method of claim 5, wherein the disposition is selected based on some probability-valued function over possible resulting vectors of expected costs or payoffs.

12. The method of claim 1, wherein the detection accuracy for each of the plurality of tests is based at least in part on a user specific measured accuracy.

13. The method of claim 1, wherein the plurality of tests are performed in a declining numerical order based on the detection accuracy probability of each test, the method further comprising bypassing tests having detection accuracy probabilities that do not exceed a detection accuracy threshold.

14. The method of claim 1, comprising assigning a reliability score to an email message identified as an email intrusion.

15. The method of claim 14, comprising one of delivering, deleting, and quarantining an email message identified as an email intrusion based on a user defined domain specific reliability threshold.

16. A computerized method for identifying email intrusions comprising:
determining a detection accuracy probability vector for an email message;
determining a relative cost matrix representing a cost of each of a plurality of possible dispositions for the email message;
computing an expected cost for each possible disposition based on the detection accuracy vector and the relative cost matrix; and
disposing of the email message based on the expected cost of the disposition.

17. A computerized method for testing email messages comprising:
determining an email system load; and
bypassing at least one of a plurality of tests for determining if an email message is an email intrusion based on the detection accuracy probability associated with the test being bypassed and the email system load.

18. A computerized method for testing email messages comprising:
determining an email system load;
computing a computational cost of performing at least one test of a plurality of tests for determining if an email message is an email intrusion;
and bypassing at least one test of the plurality of tests based on the computational cost and a detection accuracy probability of the bypassed test.

19. A computerized method for identifying email intrusions comprising:
performing on at least one email message at least one of a plurality of tests for determining if the email message is an email intrusion, each of the plurality of tests having a detection accuracy probability associated therewith;
determining an expected cost associated with each of a plurality of dispositions for the email message based on the detection accuracy probability associated with the at least one of a plurality of tests; and
disposing of the email message based on the expected cost of disposing the email message.

20. The method of claim 19 comprising performing a plurality of the tests for determining if the email message is an email intrusion and computing an overall detection accuracy probability based at least in part on the product of the detection accuracy probabilities associated with each of the tests performed, wherein the expected cost associated with each of the plurality of dispositions for the email message is based on the computed overall detection accuracy probability.
